(19) United States
(12) Patent Application Publication
(10) Pub. No.: US 2008/0227522 A1
(43) Pub. Date: Sep. 18, 2008

(54) Gaming machine

(75) Inventor: Hirobumi Toyoda, Tokyo (JP)

Correspondence Address: ARENT FOX LLP, 1050 CONNECTICUT AVENUE, N.W., SUITE 400, WASHINGTON, DC, 20036, US

(73) Assignee: ARUZE Corp.

(21) Appl. No.: 11/902,407

(22) Filed: Sep. 21, 2007

(30) Foreign Application Priority Data
Sep. 22, 2006 (JP) 2006-258101

(51) Int. Cl. G06F 17/00

(52) U.S. Cl. 463/20

(57) ABSTRACT

The present invention provides a gaming machine having a system for giving a player an incentive to continue playing the game. A slot machine 1 includes a CPU 106 which controls a variable displaying game performed by variable display and stopping display of a plurality of identification information and judges whether the result of each variable displaying game is as predetermined, a hopper 54 which provides a predetermined award when the plurality of identification information are stopped and displayed in a predetermined combination in the variable displaying game, a display unit 10 which provides a special value separately from the provision of the predetermined award when the CPU 106 judges that the result is as predetermined, and a value data memory which stores value data relating to the provided specific value. The CPU 106 provides a special award from the hopper 54 according to value data accumulatively stored in the value data memory.

### RELATED APPLICATION

This application claims the priority of Japanese Patent Application No.2006-258101 filed on Sep. 22, 2006, which is incorporated herein by reference.

### FIELD OF THE INVENTION

The present invention relates to a gaming machine, and more specifically, to a gaming machine such as a slot machine.

### DESCRIPTION OF THE RELATED ART

In conventional slot machines, a player inserts medals, and according to the player's starting operation, a variable displaying game is executed in which a plurality of reels on which identification information is displayed are varied and displayed, and on stopped displayed reels, when identification information is a predetermined combination, based on a predetermined award according to the number of inserted medals, game media (for example, medals) as an award is paid out.

In the conventional gaming machines such as slot machines, awards to be paid out are judged in advance according to a payout table stored in the gaming machine. A part of the gaming machine such as a slot machine has an award (rate) setting function, and gaming machines in which a player-led award setting can be made by the gaming machine side are provided (Japanese Unexamined Patent Publication No. 2006-158870). In these gaming machines, award setting can be changed, so that an award can be changed by setting on the gaming machine side to a rate other than the number of medals inserted by a player.

However, in these gaming machines, although the award can be changed, payout of medals corresponding to the award is completed in each variable displaying game, and it has no influence on subsequent games.

Therefore, in such a gaming machine, a player plays the game only by waiting for a so-called small prize or big prize as a predetermined combination of identification information is stopped and displayed, and there is no system for giving the player an incentive to continue playing after the variable displaying game is finished.

The present invention has been made in view of the above-described problem, and an object thereof is to provide a gaming machine having a system for giving a player an incentive to continue playing the game.

### SUMMARY OF THE INVENTION

(1) Provided is a gaming machine including: a display device which displays a plurality of symbols; a storage device which stores value data; and a control device which controls game progress and the display device, wherein the control device executes a variable displaying game which performs variable display and stopping display of the plurality of symbols and provides a predetermined award when the plurality of symbols are stopped and displayed in a predetermined combination in the variable displaying game, and judges whether the result of each variable displaying game is as predetermined, and when the judging result is as predetermined, displays a specific value on the display device separately from provision of the predetermined award, stores value data relating to the specific value in the storage device, and provides a special award according to value data accumulatively stored in the storage device.
(2) In the gaming machine according to (1) described above, the control device is made to perform control to display an image corresponding to value data stored in the storage device.
(3) In the gaming machine according to (1) described above, the control device is made to select value data from a plurality of value data stored in the storage device, and provide a special award according to the selected value data.

According to the present invention, a gaming machine having a system for giving a player an incentive to continue playing by providing a special award according to accumulatively stored value data.

Additional objects and advantage of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE INVENTION OF THE DRAWINGS

The accompanying drawings, which are incorporated in and constitute a part of the specification, illustrate embodiments of the invention, and together with the general description given above and the detailed description of the embodiments given below, serve to explain the principals of the invention.

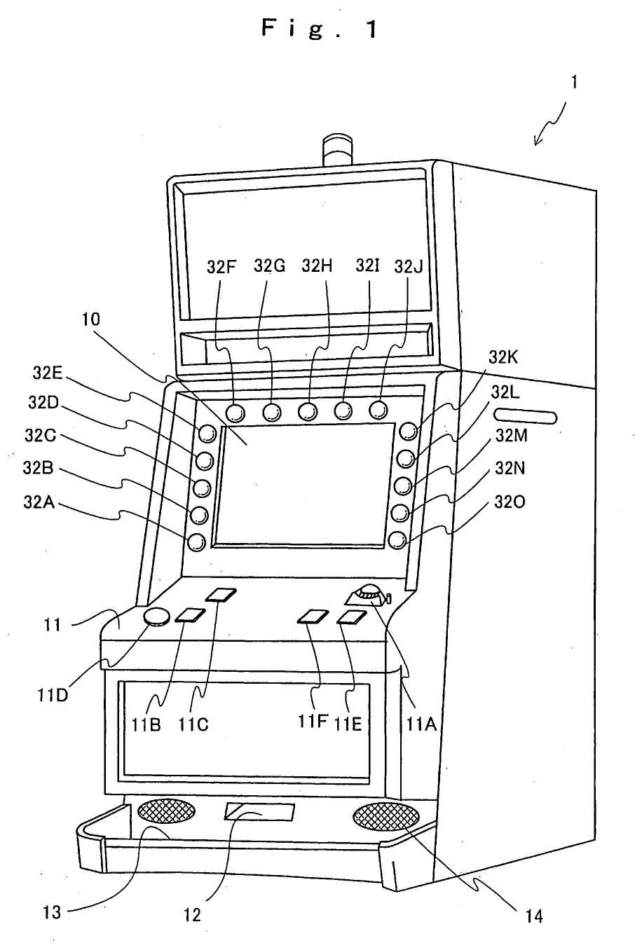

FIG. 1 is a perspective view showing an external construction of a slot machine of an embodiment of the present invention;

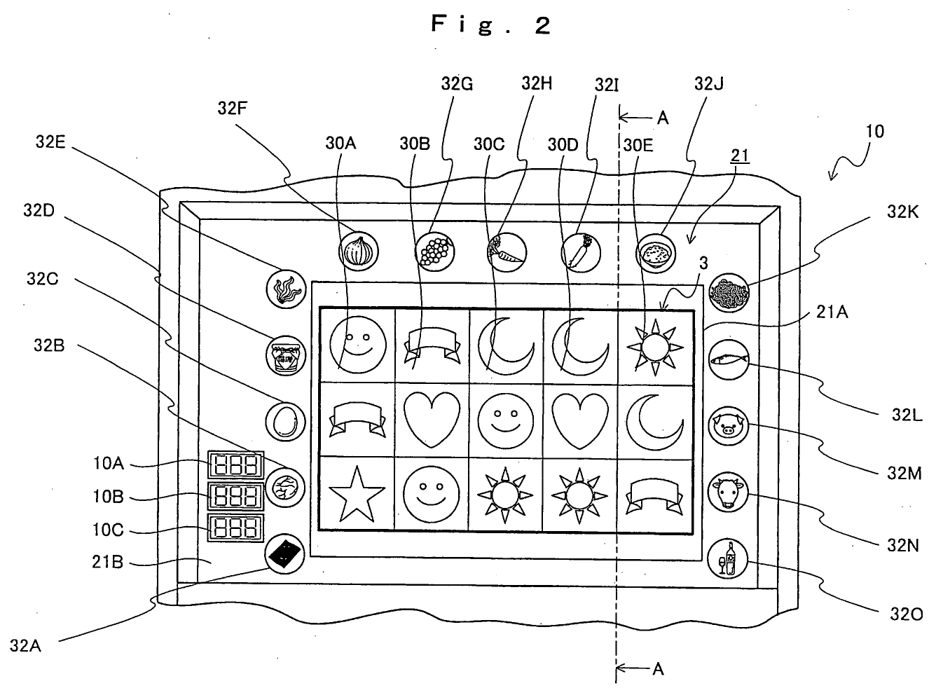

FIG. 2 is an enlarged front view showing a display area of the same slot machine in an enlarged manner;

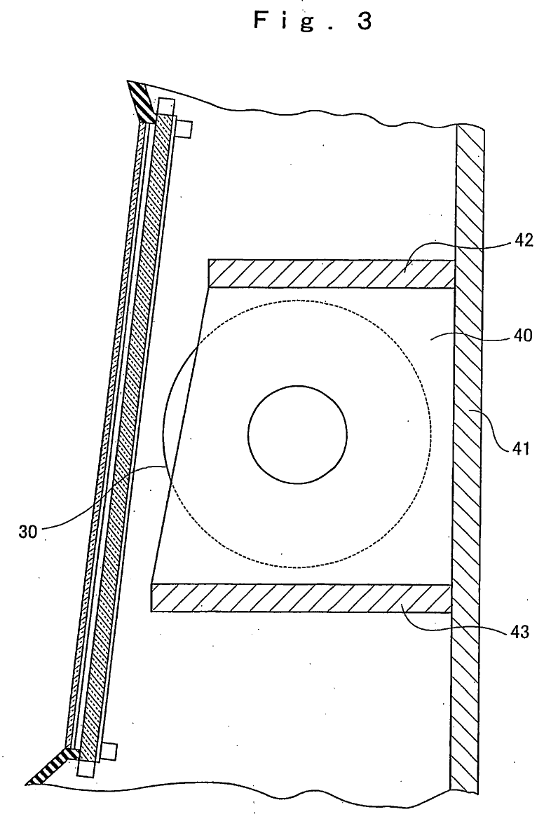

FIG. 3 is a sectional view along A-A line of FIG. 2;

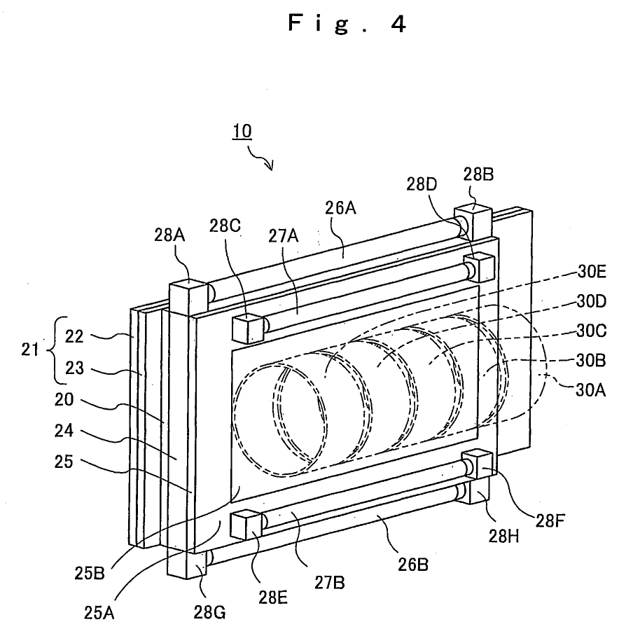

FIG. 4 is a perspective view of a general construction of a liquid crystal display device of the same slot machine from the back side;

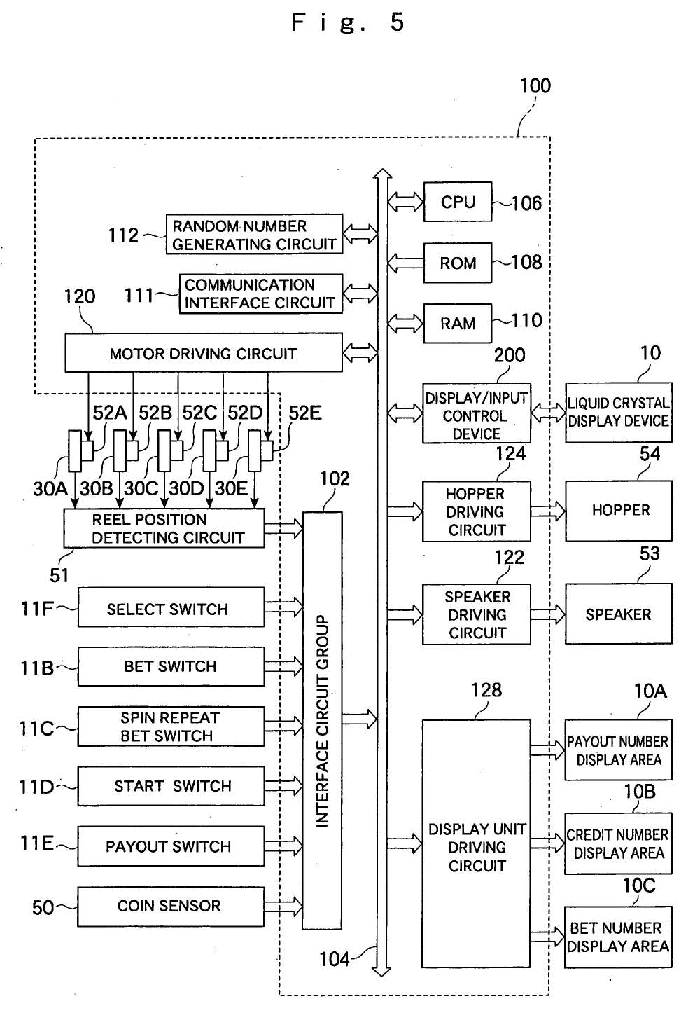

FIG. 5 is a block diagram showing an electrical configuration of a control device of the same slot machine;

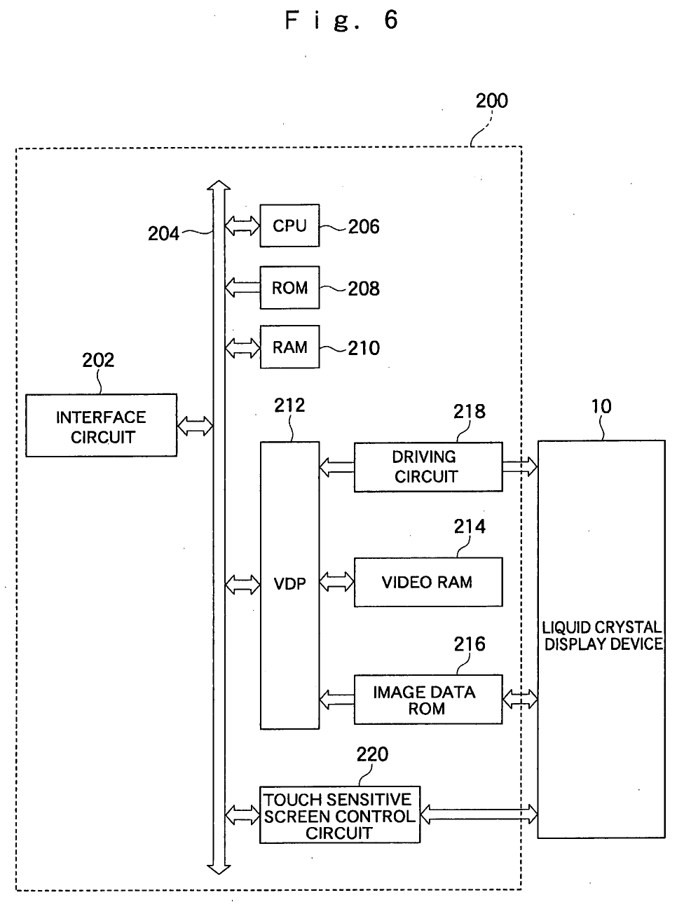

FIG. 6 is a block diagram showing an electrical configuration of a display/input control device of the same slot machine;

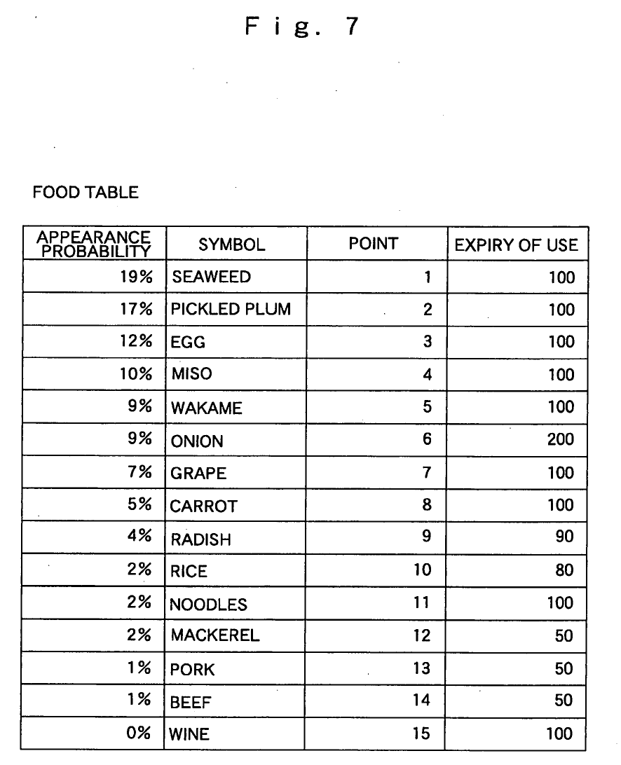

FIG. 7 is an explanatory view describing a table in the same slot machine;

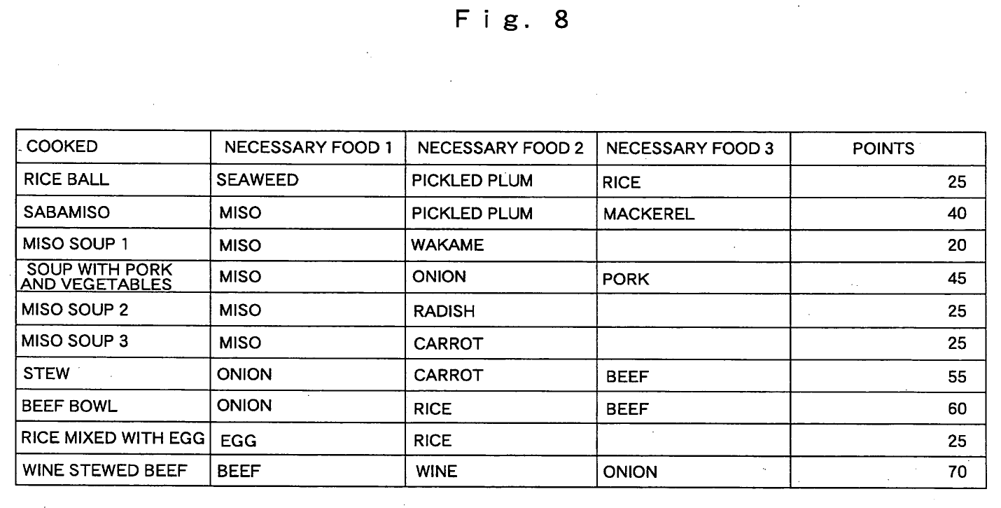

FIG. 8 is an explanatory view describing a table in the same slot machine;

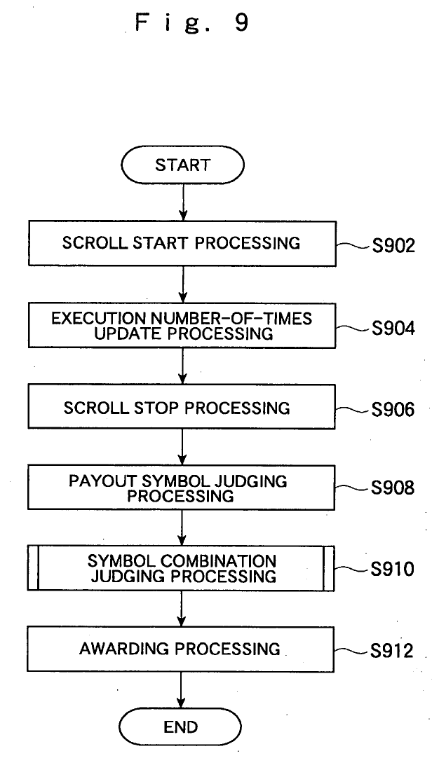

FIG. 9 is a flowchart describing a flow of processing by the same slot machine;

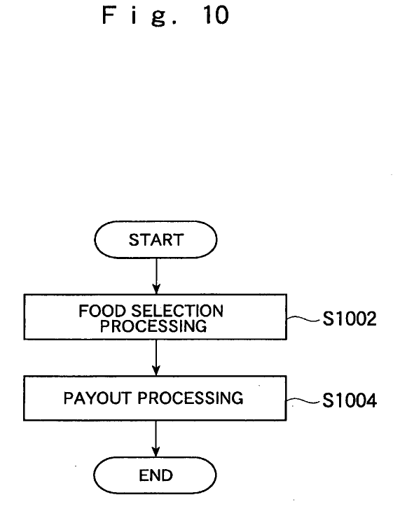

FIG. 10 is a flowchart describing a flow of processing by the same slot machine;

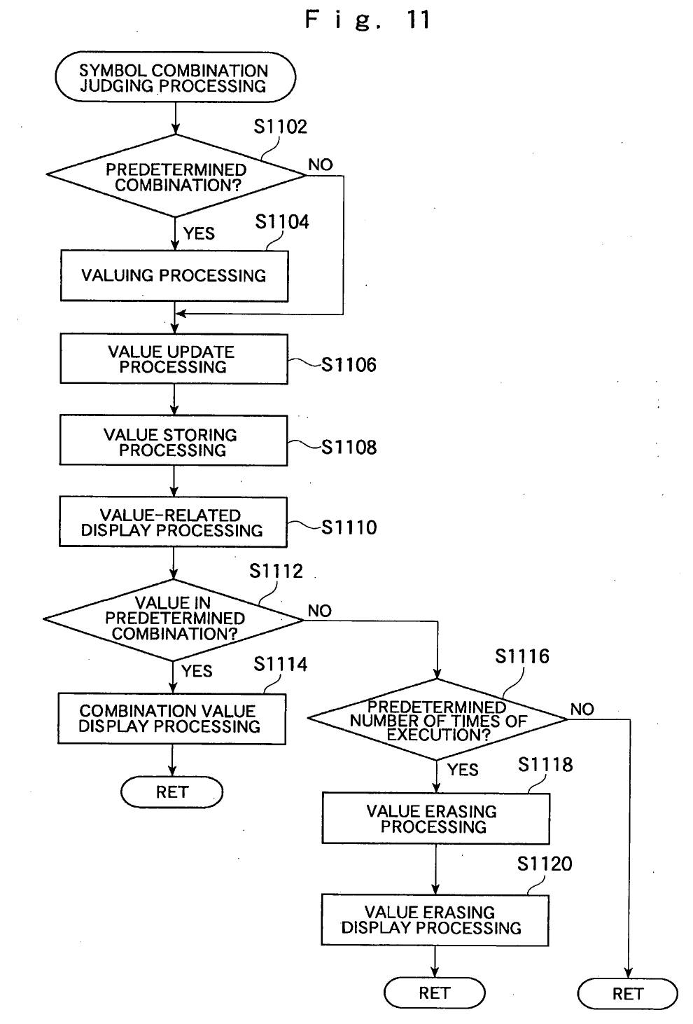

FIG. 11 is a flowchart describing a flow of processing by the same slot machine;

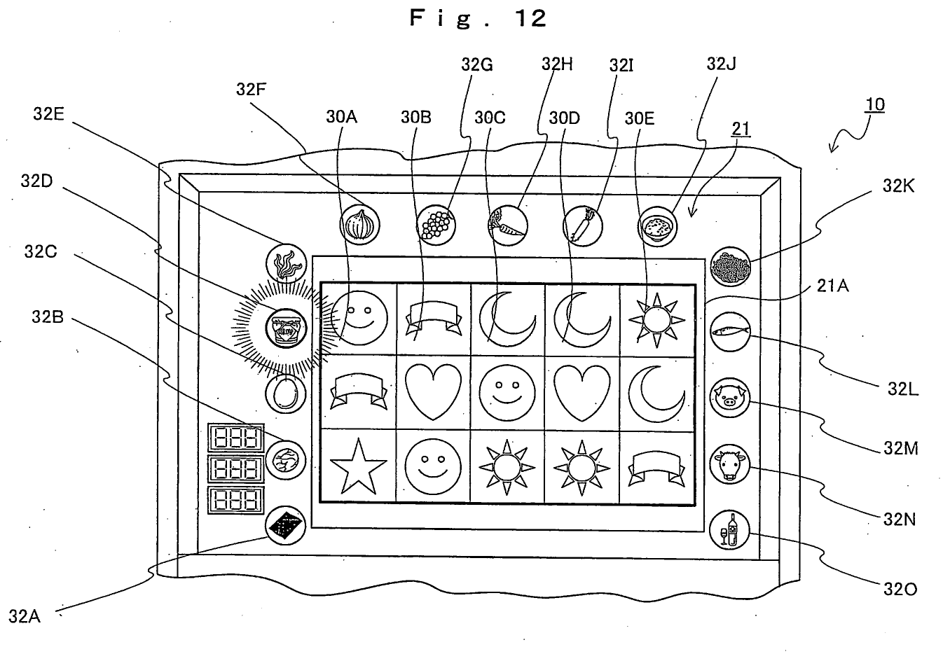

FIG. 12 is an explanatory view describing a display screen of the same slot machine;

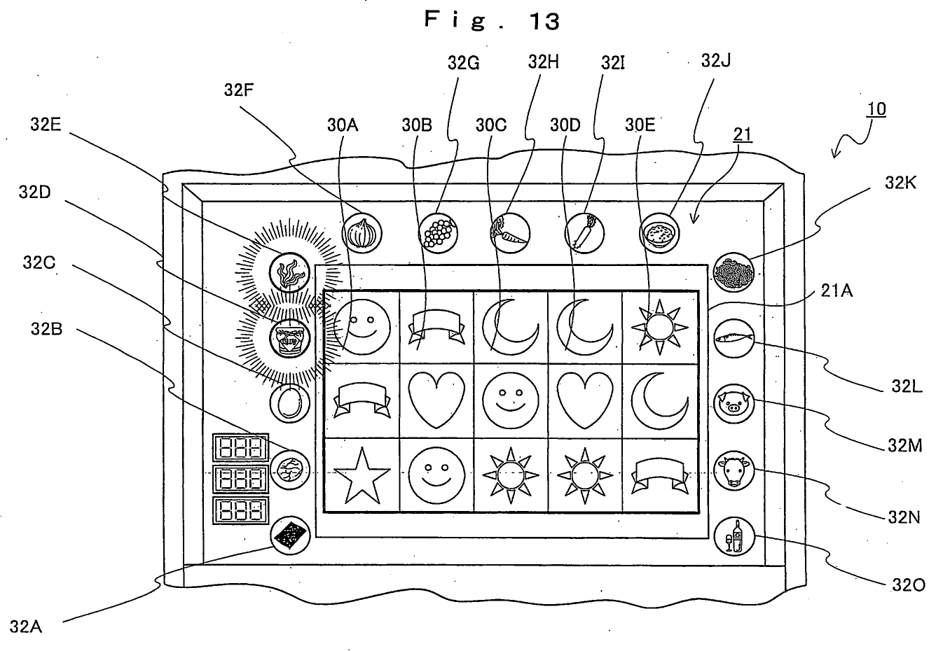

FIG. 13 is an explanatory view describing a display screen of the same slot machine;

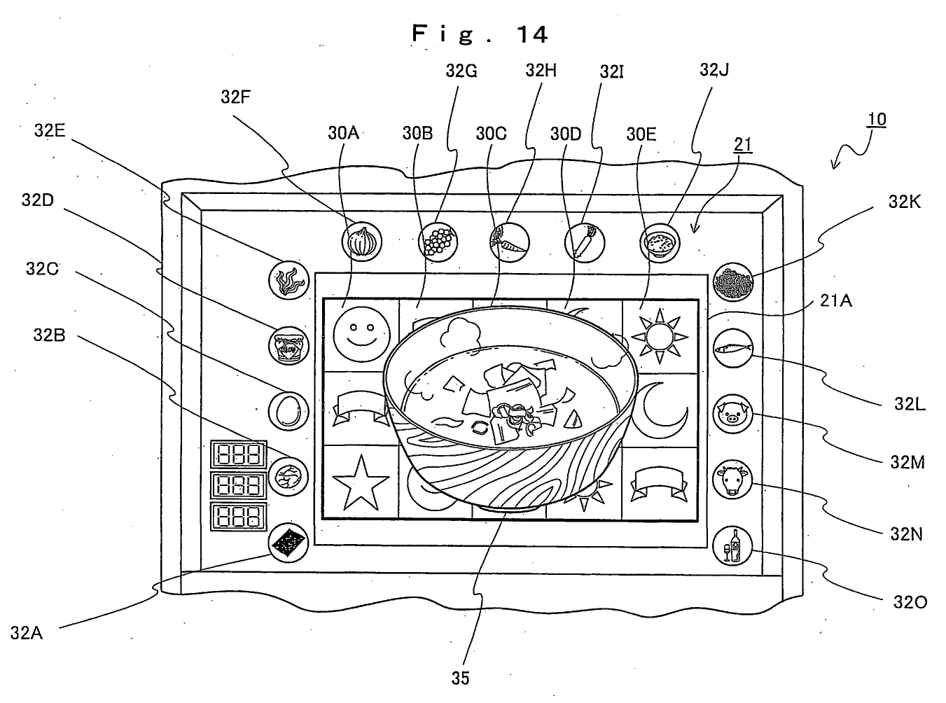

FIG. 14 is an explanatory view describing a display screen of the same slot machine;

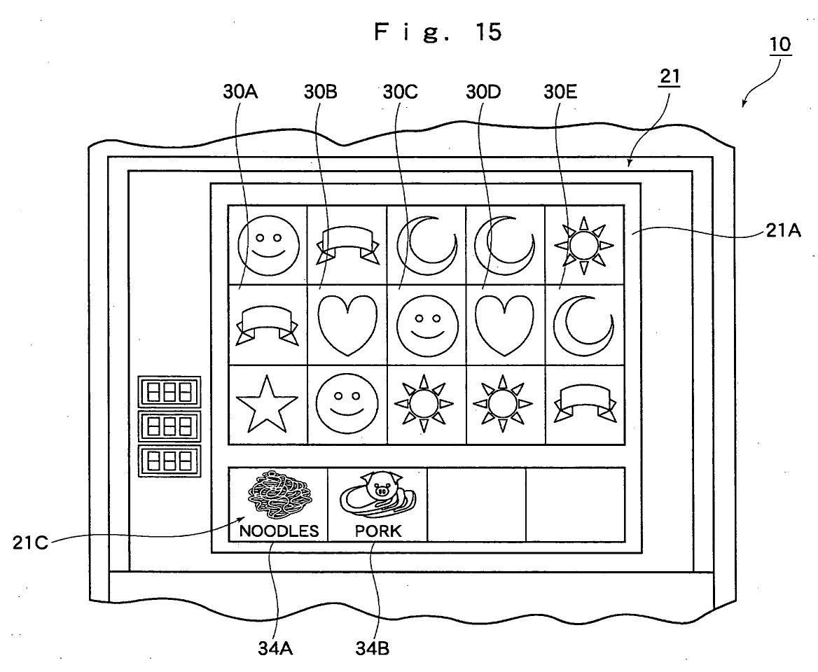

FIG. 15 is an explanatory view describing a display screen of the same slot machine;

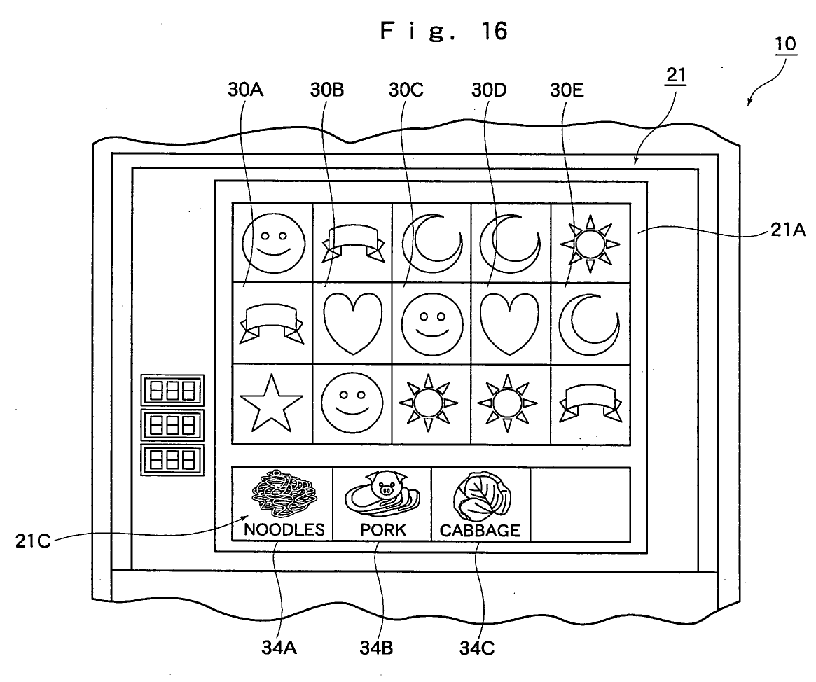

FIG. 16 is an explanatory view describing a display screen of the same slot machine;

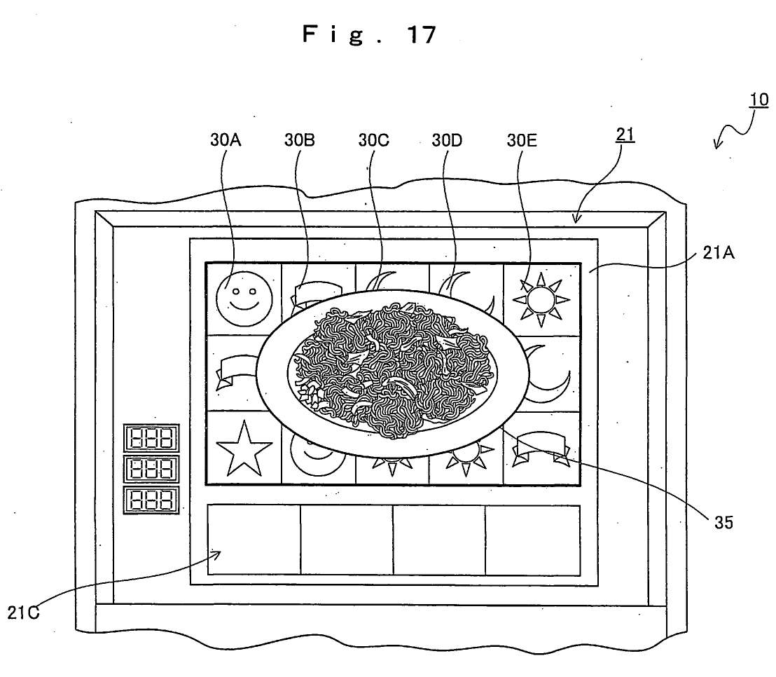

FIG. 17 is an explanatory view describing a display screen of the same slot machine;

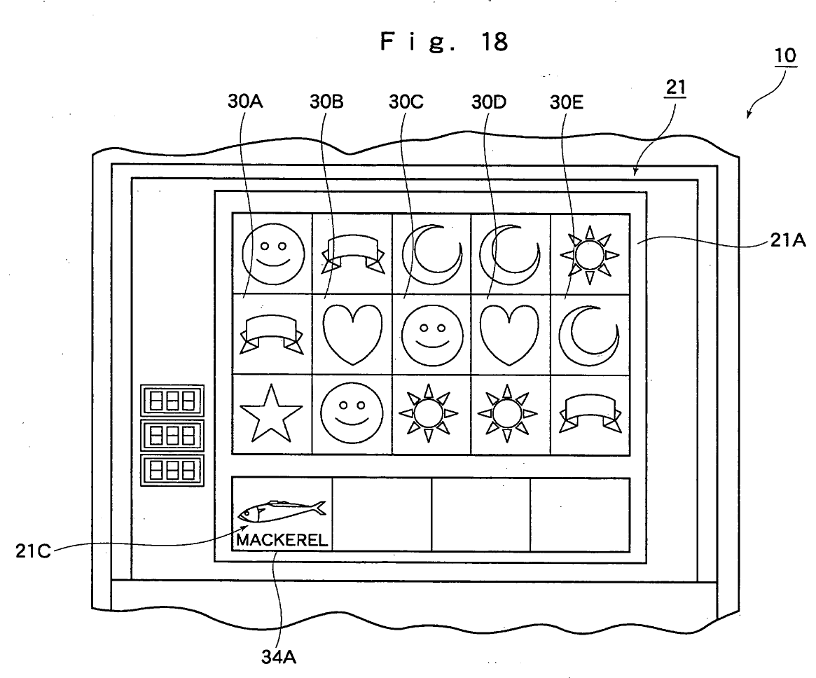

FIG. 18 is an explanatory view describing a display screen of the same slot machine;

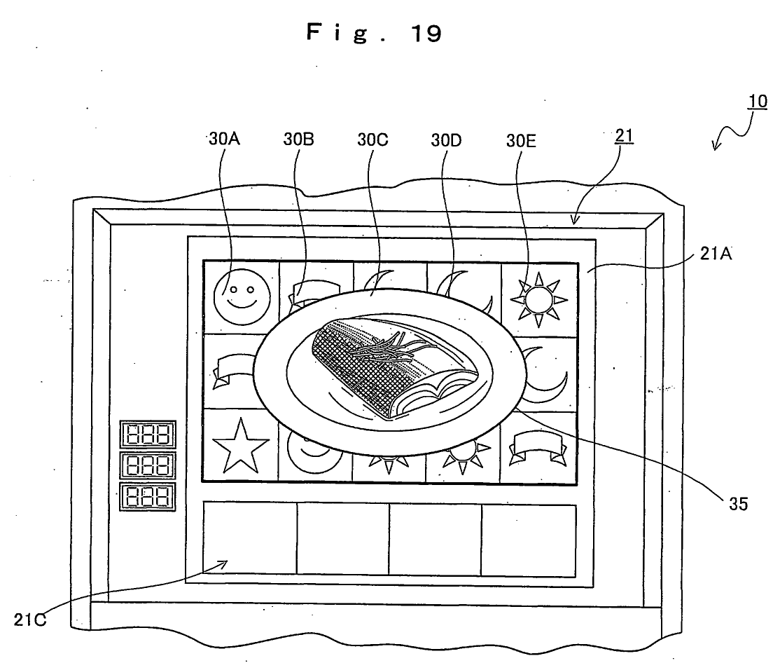

FIG. 19 is an explanatory view describing a display screen of the same slot machine; and

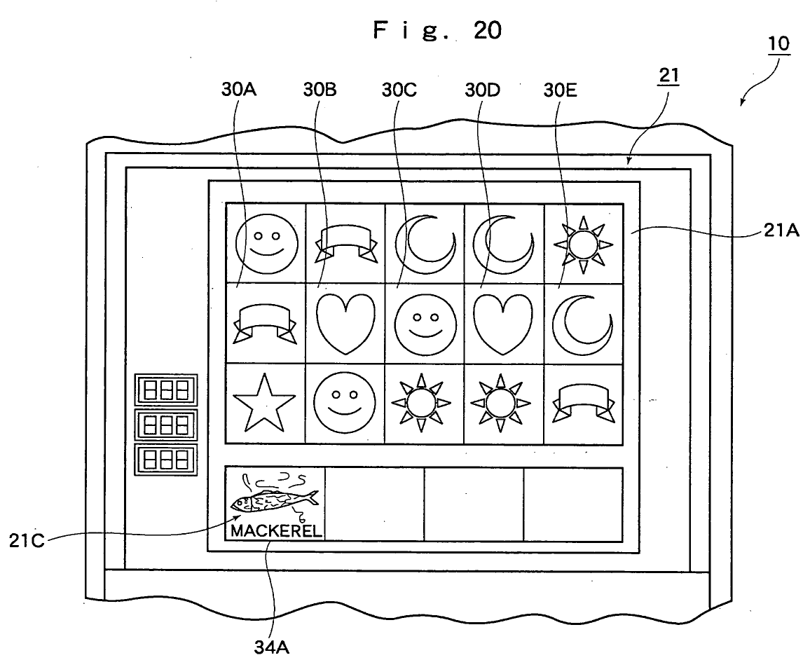

FIG. 20 is an explanatory view describing a display screen of the same slot machine.

### DESCRIPTION OF THE PREFERRED EMBODIMENTS

A gaming machine of this embodiment includes a display device which displays a plurality of symbols; a storage device which stores value data; and a control device which controls game progress and the display device, wherein the control device executes a variable displaying game which performs variable display and stopping display of the plurality of symbols and provides a predetermined award when the plurality of symbols are stopped and displayed in a predetermined combination in the variable displaying game, and judges whether the result of each variable displaying game is as predetermined, and when the judging result is as predetermined, displays a specific value on the display device separately from provision of the predetermined award, stores value data relating to the specific value in the storage device, and provides a special award according to value data accumulatively stored in the storage device.

According to this invention, when the result of a variable displaying game is as predetermined, a specific value (for example, an image of a food such as a radish or carrot) is provided, and according to value data accumulatively stored in the storage device (for example, RAM), a special award is provided (for example, medals, etc., are paid out). Thus, a gaming machine having a system for giving a player an incentive to continue playing by providing a special award according to accumulatively stored value data can be provided.

The control device can perform control to display an image corresponding to value data stored in the storage device. Accordingly, an image corresponding to the stored value data (for example, an image of a radish or carrot) is displayed on a liquid crystal panel (for example, transparent liquid crystal panel). Therefore, a gaming machine having a system for giving a player an incentive to continue playing the game by accumulatively increasing the image displayed on the liquid crystal panel according to accumulative storing of value data, can be provided.

In addition, the control device selects value data from a plurality of value data stored in the storage device, and can provide a special award according to the selected value data. Therefore, for example, by using a select switch, value data can be selected from the plurality of value data (for example, data of a plurality of foods) stored in the storage device. Furthermore, according to the selected value data (for example, pork, cabbage, noodles, and sauce), a special award is provided. Thus, a player can acquire a special award by selecting accumulatively stored value data. Therefore, the gaming machine is provided with a new gaming mode in which during continuing of gaming, value data is stored, and from a plurality of stored value data, value data is selected by using a select switch, and accordingly, a gaming machine having a system for giving a player an incentive to continue playing the game can be provided.

The provision of an award includes, for example, payout of a predetermined number of medals, making the rate advantageous for a player, and provision of a bonus game, etc.

Hereinafter, an embodiment of the present invention will be described in detail with reference to the drawings. The embodiment of the present invention is an example, and the present invention is not limited thereto.

A slot machine 1 of an embodiment of the present invention includes, as shown in FIG. 1, a display unit 10, a control panel 11, a coin payout opening 12, a coin tray 13, and a sound output portion 14. Slot machines are mainly divided into slot machines in which mechanical reels are rotated, and slot machines in which a plurality of virtual reels are rotated on a display screen, that is, so-called video slot machines. In this embodiment, the present invention is described as a slot machine using mechanical reels, however, it may be a video slot machine.

The slot machine 1 is installed at a predetermined place of a game hall such as a casino. The slot machine 1 is equipped inside with a control device 100 (see FIG. 5) for electrically controlling the respective portions. The control device 100 will be described later.

The display unit 10 is for displaying various images relating to a game including effect images and notification images. A player plays a game while viewing various images displayed on the display unit 10.

The display unit 10 has a transparent liquid crystal panel 20. The transparent liquid crystal panel 20 can be partially or entirely switched into transparent/opaque states, and can display various images. The display unit 10 will be described in detail later.

The display unit 10 has fifteen lamps 32A through 32O so as to surround the transparent liquid crystal panel 20. On the surfaces of the lamps 32A through 32O, pictures of foods (for example, seaweed and an egg, etc.) are provided, respectively.

The display unit 10 has, on its back surface sides a reel group 3 which has a plurality of pictures (symbols) drawn on the respective outer peripheral surfaces. The reel group 3 includes five mechanical reels 30A through 30E horizontally arranged in a row in a rotatable manner. The mechanical reels 30A through 30E are constructed as a plurality of symbol display areas, and perform scrolling display and stopping display of the plurality of symbols that are necessary for a basic game and include bonus trigger symbols. Various symbols of the respective mechanical reels 30A through 30E become visible when the transparent liquid crystal panel 20 becomes transparent. In this embodiment, the display device is composed of a display unit 10 and mechanical reels 30A through 30E.

The control panel 11 has a coin insertion slot 11A for inserting coins into the slot machine 1. The control panel 11 has a BET switch 11B for selecting a number of coins to be bet for an active area described later. The control panel 11 has a spin repeat bet switch 11C for playing a game again without changing the number of coins bet for the active area in the previous game. In response to a pushing operation on the BET switch 11B or spin repeat bet switch 11C, the slot machine 1 judges the number of coins bet for the active area according to this operation.

The control panel 11 has a start switch 11D as a game start accepting device for accepting an operation for starting a basic game from a player for each game. In response to a pushing operation on either the spin repeat bet switch 11C or the start switch 11D, the slot machine 1 is urged to start a game, and scrolls the five mechanical reels 30A through 30E.

The control panel 11 is provided with a payout switch 11E. The payout switch 11E is for paying-out inserted coins from the coin payout opening 12 when a player makes a pushing operation. The paid-out coins are collected in the coin tray 13.

FIG. 2 shows an enlarged view of the display unit 10. The display unit 10 includes a front panel 21. The transparent liquid crystal panel 20 is provided on the back side of the front panel 21. The front panel 21 includes a transparent display surface 21A and a picture forming area 21B in which pictures are formed. Image information displayed on the transparent liquid crystal panel 20 can be viewed through the display surface 21A of the front panel 21. The five mechanical reels 30A through 30E can be viewed via the display surface 21A when the area of the transparent liquid crystal panel 20 is transparent.

The display unit 10 is provided with a payout number display area 10A, a credit number display area 10B, and a BET number display area 10C.

The display surface 21A has an active area in which winning is determined according to a combination of symbols thereon when the rotation of all mechanical reels 30A through 30E is stopped. In detail, the active area is an area of 3 rows×5 columns consisting of a symbol on an upper stage of the mechanical reel 30A, a symbol on the middle stage of the mechanical reel 30B, a symbol on the lower stage of the mechanical reel 30C, a symbol on the middle stage of the mechanical reel 30D, and a symbol on the upper stage of the mechanical reel 30E. On the display surface 21A, not only the active area (3 rows×5 columns) but also an inactive area may also be displayed. In the case of this construction, when scrolling again, a player can estimate symbols drawn into the active area from the inactive area. Therefore, according to the present invention, a player can be provided with high expectations.

In the vicinity of the left side of the display surface 21A, lamps 32A through 32E are provided. In the vicinity of the upper side of the display surface 21A, lamps 32F through 32J are provided. In the vicinity of the right side of the display surface 21A, lamps 32K through 32O are provided. On the surface of the lamp 32A, a picture of seaweed is drawn. On the surface of the lamp 32B, a picture of a pickled plum is drawn. On the surface of the lamp 32C, a picture of an egg is drawn. On the surface of the lamp 32D, a picture of miso is drawn. On the surface of the lamp 32E, a picture of wakame is drawn. On the surface of the lamp 32F, a picture of an onion is drawn. On the surface of the lamp 32G, a picture of a grape is drawn. On the surface of the lamp 32H, a picture of a carrot is drawn. On the surface of the lamp 32I, a picture of a radish is drawn. On the surface of the lamp 32J, a picture of rice is drawn. On the surface of the lamp 32K, a picture of noodles is drawn. On the surface of the lamp 32L, a picture of a mackerel is drawn. On the surface of the lamp 32M, a picture of a pig is drawn. On the surface of the lamp 32N, a picture of a cow is drawn. On the surface of the lamp 32O, a picture of wine is drawn. These lamps 32A through 32O are turned on according to the stopping display mode of the mechanical reels 30A through 30E. The turned-on lamps 32A through 32O have a kind of value (award point described later), and by the player operating the select switch 11F, an award according to the value is provided.

The payout number display area 10A is for displaying a number of coins to be paid out when winning is judged. The credit number display area 10B is for displaying a number of credits stored in the slot machine 1. The BET number display area 10C is for displaying a number of BET as a number of coins bet for the active area. The various display areas 10A through 10C include seven-segment display portions. Alternatively, the display areas 10A through 10C may be displayed as images on the transparent liquid crystal panel 20.

FIG. 3 is a sectional view along A-A line of FIG. 2. The mechanical reels 30A through 30E are respectively supported on a reel frame 40 rotatably independently. The reel frame 40 is provided with stepping motors (not shown) for rotating and stopping the respective mechanical reels 30A through 30E. This reel frame 40 is set between an upper frame 42 and a lower frame 43 attached to a main body frame 41.

Next, a detailed structure of the display unit 10 will be described. The display unit 10 includes, as shown in FIG. 4, a transparent liquid crystal panel 20, a front panel 21 including a touch sensitive screen 22 and a display board 23, a light guiding plate 24, a reflecting film 25, fluorescent lamps 26A, 26B, 27A, and 27B that are so-called white light sources, and lamp holders 28A, 28B, 28C, 28D, 28E, 28F, 28G, and 28H. The display unit 10 includes, although not shown, a table carrier package (TCP) on which an IC for driving the transparent liquid crystal panel is mounted. The TCP is formed of a flexible substrate (not shown) connected to a terminal portion of the transparent liquid crystal panel 20. The touch sensitive screen 22 is formed of a transparent member. The display board 23 is formed of a transparent member.

The display unit 10 is provided at a predetermined distance at the front side of the mechanical reels 30A through 30E.

The transparent liquid crystal panel 20 is formed by sealing liquid crystals in a gap between a transparent substrate such as a glass plate on which a thin-film transistor layer is formed and a transparent substrate facing the above-described transparent substrate. A display mode of this transparent liquid crystal panel 20 is set to normally white. Normally white is a white display in a state that the liquid crystals are not driven (light transmitted to the display surface side is visible from the outside). By thus employing the transparent liquid crystal panel 20 set to normally white, even when a situation occurs in that the liquid crystals cannot be driven, the scrolling display and stopping display of symbols of the mechanical reels 30A through 30E can be viewed, so that a player can continue playing the game. That is, even in this situation, the player can play the game performed by the scrolling display mode and the stopping display mode of symbols of the mechanical reels 30A through 30E.

The light guiding plate 24 is for guiding light beams from the fluorescent lamps 26A and 26B to the transparent liquid crystal panel 20 (for illuminating the transparent liquid crystal panel 20), and is provided on the back side of the transparent liquid crystal panel 20 and is formed of a transparent member (having a liquid guiding function), for example, an acrylic resin having a thickness of approximately 2 centimeters.

The reflecting film 25 formed of, for example, a white polyester film or aluminum thin film on which a silver deposition film is formed is used, and reflects the light introduced to the light guiding plate 24 toward the front side of the light guiding plate 24. The reflecting film 25 includes, as shown in FIG. 4, a reflecting area 25A and a nonreflecting area (transparent area) 25B. The nonreflecting area 25B is made of a transparent material, and provided in an area including a region covering the front sides of the mechanical reels 30A through 30E of the front panel 21.

The fluorescent lamps 26A and 26B are disposed along the upper end and the lower end of the light guiding plate 24, and both ends thereof are supported by the lamp holders 28A, 28B, 28G, and 28H. Light beams irradiated from the fluorescent lamps 26A and 26B are reflected by the reflecting area 25A of the reflecting film 25 and illuminate the transparent liquid crystal panel 20. On the other hand, the fluorescent lamps 27A and 27B are disposed toward the mechanical reels 30A and 30E on an upper position and a lower position of the back side of the reflecting film 25, and both ends thereof are supported by the lamp holders 28C, 28D, 28E, and 28F. Light beams that were output from these fluorescent lamps 27A and 27B, reflected by the surfaces of the mechanical reels 30A through 30E, and made incident on the nonreflecting area 25B illuminate the transparent liquid crystal panel 20. Thus, in the display unit 10, light beams that were irradiated from the fluorescent lamps 26A and 26B and reflected by the reflecting area 25A of the reflecting film 25 and light beams that were irradiated from the fluorescent lamps 27A and 27B, reflected by the surfaces of the mechanical reels 30A through 30B, and made incident on the nonreflecting area 25B illuminate the transparent liquid crystal panel 20. Therefore, the area of the display unit 10 corresponding to the nonreflecting area 25B of the reflecting film 25 is switched to transparent or opaque states depending on whether the liquid crystals are driven, and on the other hand, the area of the liquid crystal display device corresponding to the reflecting area 25A of the reflecting film 25 becomes opaque regardless of the driving of the liquid crystals.

In the slot machine 1, only a part of the display surface of the display unit 10 is formed as an area to be switched to transparent/opaque, however, it is also allowed that the entire area of the display surface of the display unit 10 is switched to transparent/opaque. Thus, when the entire area of the display unit 10 is switched between transparent and opaque, the reflecting film 25 is entirely formed as the nonreflecting area 25B or the reflecting film 25 is omitted.

Next, the construction of the control device 100 will be described. The control device 100 is, as shown in FIG. 5, a microcomputer, including an interface circuit group 102, an input/output bus 104, a CPU 106, a ROM 108 as an example of a storage device, a RAM 110 also as an example of a storage device, and a communication interface circuit 111, a random number generating circuit 112, a motor driving circuit 120, a speaker driving circuit 122, a hopper driving circuit 124, a display unit driving circuit 128, and a display/input control device 200.

The interface circuit group 102 is connected to the input/output bus 104. The input/output bus 104 inputs and outputs data signals or address signals into and from the CPU 106.

To the interface circuit group 102, a start switch 11D is connected. A start signal output from this start switch 11D is converted into a predetermined signal in the interface circuit group 102 and supplied to the input/output bus 104.

To the interface circuit group 102, the BET switch 11B, the spin repeat bet switch 11C, and a payout switch 11E are connected. Switching signals output from the respective switches 11B, 11C, and 11E are supplied to the interface circuit group 102 and converted into predetermined signals by the interface circuit group 102, and then supplied to the input/output bus 104. A player is allowed to acquire a predetermined award by operating the payout switch 11E. Thus, the payout switch 11E is an example of the awarding controller which provides an award from a hopper 54 as an award providing unit described later based on the player's operation.

To the interface circuit group 102, a select switch 11F is connected. A start signal output from the start switch 11D is converted into a predetermined signal in the interface circuit group 102, and then supplied to the input/output bus 104. A player can perform an operation of selecting a predetermined food from the displayed lamps 32A through 32O by operating the select switch 11F. Thus, the select switch 11F is an example of a selector which selects value data among a plurality of value data stored in the RAM 210 of the display/input control device 200 functioning as a value data memory, described later.

To the interface circuit group 102, a coin sensor 50 is also connected. The coin sensor 50 is a sensor for detecting coins inserted in the coin insertion slot 11A, and is provided relating to the coin insertion slot 11A. A sensing signal output from the coin sensor 50 is supplied to the interface circuit group 102, converted into a predetermined signal by the interface circuit group 102, and then supplied to the input/output bus 104.

To the interface circuit group 102, a reel position detecting circuit 51 is also connected. The reel position detecting circuit 51 is a circuit for detecting rotating positions of the mechanical reels 30A through 30E based on pulse signals from reel rotation position sensors (not shown), and detection signals of the reel position detecting circuit 51 are also supplied to the interface circuit group 102 and converted into predetermined signals by the interface circuit group 102, and then supplied to the input/output bus 104.

To the input/output bus 104, the ROM 108 and the RAM 110 are also connected.

In response to acceptance of a basic game starting operation by the start switch 11D, the CPU 106 executes a basic game by reading-out a first game program programmed so that variable display of symbols belonging to all rows of the mechanical reels 30A through 30E is started, and then the variable display of the symbols belonging to all rows is stopped by the mechanical reels 30A through 30E, and when a combination of symbols stopped at this time indicates winning, game media corresponding to the winning combination are provided.

If a bonus trigger symbol or a combination of bonus trigger symbols appears when the symbols belonging to all rows of the mechanical reels 30A through 30E are stopped and displayed, for example, the CPU 106 reads-out a second game program and executes a free game. Thus, the CPU 106 is an example of a variable displaying game execution controller which controls the variable displaying game performed by variable display and stopping display of a plurality of identification information. Thus, the CPU 106 is an example of the game result judging unit which judges whether the result of each variable displaying game is as predetermined.

The ROM 108 stores a control program for totally controlling the slot machine 1, initial data for executing the control program, and various data tables to be used for a lottery.

The RAM 110 temporarily stores flags and variables to be used in the control program.

To the input/output bus 104, a communication interface circuit 111 is also connected. This communication interface circuit 111 is a circuit for communicating with a server and the like via various communication networks including a public telephone network and a LAN.

To the input/output bus 104, a random number generating circuit 112 for generating random numbers is also connected. This random number generating circuit 112 generates random numbers in a predetermined range, for example, random numbers included in “0” through “65535.” Alternatively, random numbers may be generated by arithmetic processing of the CPU 106.

To the input/output bus 104, a motor driving circuit 120 for driving stepping motors 52A through 52E and a display unit driving circuit 128 for driving various display areas 10A through 10C are connected. The CPU 106 controls operations of the display areas 10A through 10C and the stepping motors 52A through 52E via the motor driving circuit 120 and the display unit driving circuit 128 in response to occurrence of a predetermined phenomenon.

To the input/output bus 104, a speaker driving circuit 122 for driving a speaker 53 is also connected. The CPU 106 reads-out sound data stored in the ROM 108 and transmits this readout sound data to the speaker driving circuit 122 via the input/output bus 104. Thereby, predetermined effect sounds are output from the speaker 53.

To the input/output bus 104, the hopper driving circuit 124 for driving the hopper 54 is also connected. The CPU 106 outputs a drive signal to the hopper driving circuit 124 via the input/output bus 104 when a payout signal is input from the payout switch 11E. Thereby, the hopper 54 pays-out coins corresponding to a remaining number of credits at this time stored in a predetermined memory area of the RAM 110. Thus, the hopper 54 is an example of an award providing unit which provides a predetermined award when the plurality of identification information are stopped and displayed in a predetermined combination. Thus, the hopper driving circuit 124 is an example of an award controller which controls the award of the award providing unit.

To the input/output bus 104, a display/input control device 200 is also connected. The CPU 106 generates an image display command corresponding to the playing state and result, and outputs this generated image display command to the display/input control device 200 via the input/output bus 104. When the image display command is input from the CPU 106, the display/input control device 200 generates a drive signal for driving the display unit 10 based on the input image display command, and outputs this generated drive signal to the display unit 10. Thereby, on the transparent liquid crystal panel 20 of the display unit 10, a predetermined image is displayed. The display/input control device 200 transmits a signal input on the touch sensitive screen 22 on the display unit 10 as an input signal to the CPU 106 via the input/output bus 104.

Herein, the construction of the display/input control device 200 will be described. The display/input control device 200 is a submicrocomputer which performs image display processing and controls inputs from the touch sensitive screen 22 as shown in FIG. 6, and includes an interface circuit 202, an input/output bus 204, a CPU 206, a ROM 208 as an example of a storage device, and a RAM 210 also as an example of a storage device, a VDP 212, a video RAM 214 as an example of a storage device, an image data ROM 216 also as an example of a storage device, a driving circuit 218 and a touch sensitive screen control circuit 220.

The interface circuit 202 is connected to the input/output bus 204. An image display command output from the CPU 106 on the control device 100 side is supplied to the input/output bus 204 via the interface circuit 202. The input/output bus 204 inputs and outputs data signals or address signals into and from the CPU 206.

To the input/output bus 204, the ROM 208 and the RAM 210 are also connected. The ROM 208 stores a display control program for generating a drive signal to be supplied to the display unit 10 based on the image display command from the CPU 106 on the control device 100 side. On the other hand, the RAM 210 stores flags and variables to be used in the display control program.

To the input/output bus 204, the VDP 212 is also connected. This VDP 212 is a processing device which includes a so-called sprite circuit, a screen circuit, and a pallet circuit, etc., and can perform various processings for making the display unit 10 display images. To the VDP 212, the video RAM 214 for storing image data corresponding to the image display command from the CPU 106 on the control device 100 side, and the image data ROM 216 storing various image data including the above-described effect image data are connected. Furthermore, to the VDP 212, a driving circuit 218 which outputs a drive signal for driving the display unit 10 is also connected.

The CPU 206 stores, in the video RAM 214, image data to be displayed on the display unit 10 according to the image display command from the CPU 106 on the control device 100 side by reading-out and executing the display control program stored in the ROM 208. This image display command includes various image display commands such as an effect image display command.

The image data ROM 216 stores various image data including effect image data, etc.

The touch sensitive screen control circuit 220 transmits a signal input on the touch sensitive screen 22 on the display unit 10 as an input signal to the CPU 106 via the input/output bus 204.

### Food Table

A food table to be stored in the ROM 28 of the display/input control device 200 will be described with reference to FIG. 7. As shown in FIG. 7, when the mechanical reels 30A through 30E are stopped and displayed in a predetermined combination, the CPU 206 of the display/input control device 200 selects a food (value) according to the appearance probability described below, and stores value data corresponding to the value in the RAM 210. A lamp corresponding to the food selected by the CPU 206 of the display/input control device 200 among 32A through 32O is turned on. In the value data corresponding to the selected food in the RAM 210, the award point increases (for example, a grape changes into wine) or lowers (spoils) or is thrown away (erased) from the RAM 210 according to expiry of use (execution number-of-times data). Thus, the CPU 106 functions as an execution number-of-times judging unit, and is also an example of a value data erasing unit which erases value data judged as reaching a predetermined number of times of execution by the above-described function.

As shown in FIG. 7, an appearance probability of seaweed is 19 percent, its award point is 1 point, and its expiry of use is up to 1000 rotations. An appearance probability of a pickled plum is 17 percent, its award point is 2 points, and its expiry of use is up to 100 rotations. An appearance probability of an egg is 12 percent, its award point is 3 points, and its expiry of use is up to 100 rotations. An appearance probability of miso is 10 percent, its award point is 4 points, and its expiry of use is up to 100 rotations. An appearance probability of wakame is 9 percent, its award point is 5 points, and its expiry of use is up to 100 rotations. An appearance probability of an onion is 9 percent, its award point is 6 points, and its expiry of use is up to 200 rotations. An appearance probability of a grape is 7 percent, its award point is 7 points, and its expiry of use is up to 100 rotations. An appearance probability of a carrot is 5 percent, its award point is 8 points, and its expiry of use is up to 100 rotations. An appearance probability of a radish is 4 percent, its award point is 9 points, and its expiry of use is up to 90 rotations. An appearance probability of rice is 2 percent, its award point is 10 points, and its expiry of use is up to 80 rotations. An appearance probability of noodles is 2 percent, its award point is 11 points, and its expiry of use is up to 100 rotations. An appearance probability of mackerel is 2 percent, its award point is 12 points, and its expiry of use is up to 50 rotations. An appearance probability of pork is 1 percent, its award point is 13 points, and its expiry of use is up to 50 rotations. An appearance probability of beef is 1 percent, its award point is 14 points, and its expiry of use is up to 50 rotations. An appearance probability of wine is 0 percent, its award point is 15 points, and its expiry of use is up to 100 rotations. Thus, the appearance probability of wine is 0 percent, and it is not normally selected. When a grape is selected and a predetermined number of times of execution (100 rotations) is reached, the grape changes into wine. When a player operates the payout switch 11E, medals (game media) corresponding to the award points are paid out from the hopper 54. Thus, the display/input control device 200 has the RAM 210 which stores value data corresponding to values, and is an example of a value data memory for storing value data having execution number-of-times data on which a number of times of execution of the variable displaying game since the value data is stored. Thus, the hopper 54 is an example of the award providing unit which provides an award according to the execution number-of-times data of value data stored in the value data memory when the awarding controller is operated. In this embodiment, an example of value data is described by using the food table, however, the present invention is not limited to this, and the value data may be in another form.

### Cooking Table

A cooking table to be stored in the ROM 208 of the display/input control device 200 will be described with reference to FIG. 8. The CPU 106 judges whether the foods are in a predetermined combination according to detection signals from the select switch 11F operated by the player, and when they are in the predetermined combination stored in the cooking table, award points according to the combination are stored in the RAM 210. When value data stored in the RAM 210 is in a predetermined combination stored in the cooking table, the CPU 106 automatically stores award points corresponding to the combination in the RAM 210 and automatically provides an award according to the award points. Thus, the CPU 106 is an example of a value data combination judging unit which judges whether a plurality of value data stored in the value data memory are in a predetermined combination. Thus, the hopper 54 is an example of an award providing unit which automatically provides an award according to a predetermined combination when the value data combination judging unit judges that the plurality of value data stored in the value data memory are in the predetermined combination.

As shown in FIG. 8, as a predetermined combination, foods necessary for making a rice ball are seaweed, a pickled plum, and rice, and 25 points are added as award points. As a predetermined combination, foods necessary for cooking sabamiso are miso, a pickled plum, and mackerel, and 40 points are added as award points. As a predetermined combination, foods necessary for cooking miso soup 1 are miso and wakame, and 20 points are added as award points. As a predetermined combination, foods necessary for cooking soup with pork and vegetables are miso, an onion, and pork, and 45 points are added as award points. As a predetermined combination, foods necessary for cooking miso soup 2 are miso and a radish, and 25 points are added as award points. As a predetermined combination, foods necessary for cooking miso soup 3 are miso and a carrot, and 25 points are added as award points. As a predetermined combination, foods necessary for cooking stew are an onion, a carrot, and beef, and 55 points are added as award points. As a predetermined combination, foods necessary for cooking a beef bowl are an onion, rice, and beef, and 60 points are added as award points. As a predetermined combination, foods necessary for cooking rice mixed with egg are an egg and rice, and 25 points are added as award points. As a predetermined combination, foods necessary for cooking wine stewed beef are beef, wine, and an onion, and 70 points are added as award points. In this embodiment, examples of the predetermined combination are described, however, the present invention is not limited to these and may be other combinations. In the present invention, when the value data stored in the RAM 210 is in a predetermined combination, an award is automatically provided. Therefore, even when soup with pork and vegetables (45 award points) is aimed at as the predetermined combination and miso and pork are stored as value data, if the food acquired next is wakame, the combination becomes the miso soup 1 (20 award points). However, if the food acquired next is an onion, the combination becomes soup with pork and vegetables. Therefore, the player is interested in the value data to be acquired next, so that the results of gaming are continued, and therefore, a gaming machine which can maintain the player's interest can be provided.

Next, the flow of progress of the game in the slot machine 1 will be described with reference to the flowchart described below.

### Main Processing

Main processing will be described with reference to FIG. 9.

At Step S902, scroll start processing is performed. In this processing, in order to start rotating (scrolling) the five mechanical reels 30A through 30E in response to a pushing operation on the spin repeat bet switch 11C or the start switch 11D bya player, the CPU 106 performs processing of transmitting a control signal to the motor driving circuit 120. When this processing is finished, the process is shifted to Step S904.

At Step S904, execution number-of-times updating processing is performed. In this processing, the CPU 106 performs processing of updating the number of times of execution stored in the RAM 110. When this processing is finished, the process is shifted to Step S906. Thus, the display/input control device 200 functions as a value data memory which stores value data including execution number-of-times data containing a number of times of execution of the variable displaying game since the value data is stored.

At Step S906, scroll stop processing is performed. In this processing, when a predetermined time elapses, in order to stop all mechanical reels 30A through 30E, the CPU 106 transmits a control signal to the motor driving circuit 120. When this processing is finished, the process is shifted to Step S908. Thus, the CPU 106 functions as a variable displaying game execution controller which controls a variable displaying game performed by variable display and stopping display of a plurality of identification information.

At Step S908, payout symbol judging processing is performed. In this processing, the CPU 106 judges whether a combining symbol is being stopped on a predetermined reel (for example, mechanical reel 30A) of an active area. The CPU 106 counts the number of scatter symbols being stopped in the active area in this process. The CPU 106 stores the number of scatter symbols in the RAM 110. When this processing is finished, the process is shifted to Step S910. Thus, the CPU 106 functions as a game result judging unit which judges whether the result of each variable displaying game is as predetermined.

At Step S910, symbol combination judging processing is performed. In this processing, the CPU 106 performs symbol combination judging processing. The symbol combination judging processing will be described later. When this processing is finished, the process is shifted to Step S912.

At Step S912, awarding processing is performed. In this processing, in order to provide an award based on award data stored in the RAM 110, the CPU 106 transmits a control signal to the hopper driving circuit 124. The hopper driving circuit 124 drives the hopper 54 according to the received control signal and pays out game media. In detail, the CPU 106 provides an award based on award data stored in the RAM 110 according to the control signal from the payout switch 11E. The CPU 106 refers to the cooking table (see FIG. 8), and when value data stored in the display/input control device 200 is in a predetermined combination, the CPU provides an award based on award data stored in the RAM 110. When this processing is finished, this subroutine is ended. Thus, in the variable displaying game, when a plurality of identification information are stopped and displayed in a predetermined combination, the hopper 54 functions as an award providing unit which provides a predetermined award. Thus, the hopper 54 also functions as an award providing unit which provides a special award according to accumulatively stored value data in the value data memory. The hopper 54 also functions as an award providing unit which provides a special award according to value data selected by the selector (select switch 11F) . Thus, the payout switch 11E functions as an awarding controller which makes the award providing unit provide an award based on the player's operation. The hopper 54 also functions as an award providing unit which provides an award according to execution number-of-times data of value data stored in the value data memory when the awarding controller is operated. The hopper 54 also functions as an award providing unit which automatically provides an award according to a predetermined combination when the value data combination judging unit judges that the plurality of value data stored in the value data memory are in a predetermined combination.

### Cooking Processing

Cooking processing will be described with reference to FIG. 10.

At Step S1002, food selection processing is performed. In this processing, the CPU 106 performs processing of selecting lamps being turned on among the lamps 32A through 32O according to an operation on the select switch 11F by the player. When this processing is finished, the process is shifted to Step S1004. Thus, the select switch 11F functions as a selector for selecting value data among a plurality of value data stored in the value data memory.

At Step S1004, payout processing is performed. In this processing, the CPU 106 transmits award data to the RAM 110 by referring to the food table (see FIG. 7) and the cooking table (see FIG. 8) based on value data corresponding to the lamps selected at Step S1002 among the lamps 32A through 32O and the combination of the value data. When this processing is finished, this subroutine is ended. The CPU 106 performs awarding at S912 based on the award data stored in the RAM 110 at Step S1004. (Symbol combination judging processing The subroutine to be executed at Step S910 of FIG. 9 will be described with reference to FIG. 11.

At Step S1102, processing of judging whether the combination is as predetermined. In this processing, when the CPU 106 judges that the mechanical reels 30A through 30E stopped and displayed are in a predetermined combination, it shifts the process to Step S1104, and when the CPU judges that they are not in a predetermined combination, it shifts the process to Step S1106.

At Step S1104, valuing processing is performed. In this processing, when the CPU 106 judges that the stopped mechanical reels 30A through 30E are in a predetermined result, it transmits a control signal to the display/input control device 200. The display/input control device 200 controls the displays of the lamps 32A through 32O according to the received control signal. Thus, the display unit 10 is an example of a valuing unit which provides a special value separately from provision of the predetermined award when the game result judging unit judges that the result is as predetermined.

At Step S1106, value update processing is performed. In this processing, when the value data stored in the RAM 210 is updated according to the number of times of execution, the CPU 106 performs update processing. When this processing is finished, the process is shifted to Step S1108.

At Step S1108, value storing processing is performed. In this processing, the CPU 106 performs processing of storing value data in the RAM 210 of the display/input control device 200. When this processing is finished, the process is shifted to Step S1110. Thus, the display/input control device 200 functions as a value data memory which stores value data concerning a specific value provided by the valuing unit.

At Step S1110, value-related display processing is performed. In this processing, the CPU 106 stores data for displaying a value-related effect image in the RAM 110 from the ROM 108 and transmits the same to the display/input control device 200. In the display/input control device 200, the VDP 212 reads-out various image data such as background image data and effect image data from the image data ROM 216 based on the data for displaying the value-related effect image from the CPU 106, and makes the display unit 10 display these in a superposing manner. When this processing is finished, the process is shifted to Step S1112. Thus, the display unit 10 is an example of a display which displays images. The display/input control device 200 is an example of a display controller which controls displaying on the display. Furthermore, the display/input control device 200 is an example of a display controller which controls displaying of images according to value data stored in the value data memory.

At Step S1112, processing of judging whether values are in a predetermined combination is performed. In this processing, when the CPU 106 judges that the values are in a predetermined combination, the process is shifted to Step S1114, and when it is judged that the values are not in a predetermined combination, the process is shifted to Step S1116. Thus, the CPU 106 is an example of a value data combination judging unit which judges whether a plurality of value data stored in the value data memory are in a predetermined combination.

At Step S1114, combination value display processing is performed. In this processing, the CPU 106 stores data for displaying a combination value effect image in the RAM 110 from the ROM 108, and transmits the same to the display/input control device 200. In the display/input control device 200, the VDP 212 reads-out various image data such as background image data and effect image data from the image data ROM 216 based on the data for displaying a combination value effect image from the CPU 106, and displays these on the display unit 10 in a superposing manner. When this processing is finished, this subroutine is ended.

At Step S1116, processing of judging whether a predetermined number of times of execution is reached is performed. In this processing, when the CPU 106 judges that the predetermined number of times of execution is reached based on the number of times of execution stored at Step S904, it shifts the process to Step S118, and when the CPU judges that the predetermined number of times of execution is not reached, it ends this subroutine. In detail, the CPU 106 judges a number of times of execution since the storing of value data for each value data stored in the display/input control device 200. In detail, when the value data is seaweed, the CPU 106 judges whether the number of times of execution since the storing has reached 100. For example, when the value data is mackerel, the CPU 106 judges whether the number of times of execution since the storing has reached 500. Thus, the CPU 106 is an example of an execution number-of-times judging unit which judges the number of times of execution from execution number-of-times data of value data stored in the value data memory.

At Step S1118, value erasing processing is performed. In this processing, the CPU 106 erases value data whose number of times of execution has exceeded the predetermined number of times among the value data stored in the display/input control device 200 from the RAM 210 of the display/input control device 200. When this processing is finished, the process is shifted to Step S1120. The CPU 106 also functions as a value data erasing unit which erases value data whose number of times of execution was judged as reaching the predetermined number of times by the execution number-of-times judging unit.

At Step S1120, value erasing display processing is performed. In this processing, the CPU 106 stores data for displaying a value erasing effect image in the RAM 110 from the ROM 108, and transmits the same to the display/input control device 200. In the display/input control device 200, the VDP 212 reads various images such as background image data and effect image data from the image data ROM 216 based on the data for displaying a value erasing effect image from the CPU 106, and displays these on the display unit 10 in a superposing manner. When this processing is finished, this subroutine is ended.

### Description of Display Screen

FIG. 12 is an explanatory view showing a display screen on which a predetermined value is provided in a first embodiment. As shown in FIG. 12, on the display surface 21A of the front panel 21, the mechanical reels 30A through 30E are stopped and displayed. In response to the stop of the mechanical reels 30A through 30E in a predetermined combination, the lamp 32 (miso) is turned on and displayed among the lamps 32A through 32O.

FIG. 13 is an explanatory view showing a display screen on which a predetermined value is provided in the first embodiment. As shown in FIG. 13, on the display surface 21A of the front panel 21, mechanical reels 30A through 30E are stopped and displayed. According to the stop of the mechanical reels 30A through 30E in a predetermined combination, the lamp 32D (miso) and the lamp 32E (wakame) are turned on and displayed among the lamps 32A through 32O. Thereby, a predetermined combination of value data is obtained (see FIG. 8).

FIG. 14 is an explanatory view showing a display screen on which values are in a predetermined combination in the first embodiment. As shown in FIG. 14, on the display surface 21A of the front panel 21, the mechanical reels 30A through 30E are stopped and displayed. On the display surface 21A of the front panel 21, an image 35 of a dish (for example, miso soup with wakame, etc.) obtained from a combination of foods is displayed. The predetermined combination is obtained, so that the lamps 32A through 32O are turned off on the display.

FIG. 15 is an explanatory view showing a display screen on which a predetermined value is provided in a second embodiment. As shown in FIG. 15, on the display surface 21A of the front panel 21, the mechanical reels 30A through 30E are stopped and displayed. In the food display area 21C of the front panel 21, a food image 34A (noodles) is displayed as a value. In the food display area 21C of the front panel 21, a food image 34B (pork) is displayed as a value.

FIG. 16 is an explanatory view showing a display screen in the second embodiment. As shown in FIG. 16, on the display surface 21A of the front panel 21, the mechanical reels 30A through 30E are stopped and displayed. In the food display area 21C of the front panel 21, a food image 34A (noodles) is displayed as a value. Furthermore, in the food display area 21C of the front panel 21, a food image 34B (pork) is displayed as a value. In addition, in the food display area 21C of the front panel 21, a food image 34C (cabbage) is displayed as a value.

FIG. 17 is an explanatory view showing a display screen on which values are in a predetermined combination in the second embodiment. As shown in FIG. 17, on the display surface 21A of the front panel 21, the mechanical reels 30A through 30E are stopped and displayed. On the display surface 21A of the front panel 21, an image 35 of a dish (for example, pan-fried noodles) obtained from a combination of foods is displayed. The value data is combined, so that no image is displayed in the food display area 21C of the front panel 21.

FIG. 18 is an explanatory view showing a display screen in the second embodiment. As shown in FIG. 18, on the display surface 21A of the front panel 21, the mechanical reels 30A through 30E are stopped and displayed. In the food display area 21C of the front panel 21, a food image 34A (mackerel) is displayed.

FIG. 19 is an explanatory view showing a display screen on which values are in a predetermined combination in the second embodiment. As shown in FIG. 19, on the display surface 21A of the front panel 21, the mechanical reels 30A through 30E are stopped and displayed. On the display surface 21A of the front panel 21, an image 35 of a dish (for example, sabamiso) obtained from a combination of foods is displayed. The value data is combined, so that no image is displayed in the food display area 21C of the front panel 21.

FIG. 20 is an explanatory view showing a display screen on which a value is lost in the second embodiment. As shown in FIG. 20, on the display surface 21A of the front panel 21, the mechanical reels 30A through 30E are stopped and displayed. In the food display area 21C of the front panel 21, a food image 34A (rotten mackerel) whose value is lost is displayed. Thus, when a predetermined number of times of execution is reached since the value is provided, the value is lost. Therefore, the player can enjoy selecting whether the player acquires the value immediately or aims at a higher award by combining the value.

Thus, when the result of the variable displaying game is as predetermined, a specific value (for example, a food such as a radish or carrot) is provided, and according to accumulatively stored value data in the value data memory, a special award is provided (for example, game media such as medals are paid out). Thus, a gaming machine which has a system for giving a player an incentive to continue playing the game by providing a special award according to accumulatively stored value data can be provided.

Furthermore, images (for example, images of a radish and carrot) corresponding to stored value data are displayed on the display (for example, liquid crystal display device). Therefore, a gaming machine having a system for giving a player an incentive to continue playing the game by accumulatively increasing images to be displayed on the display according to accumulative storing of value data, can be provided.

Furthermore, value data can be selected from a plurality of value data (for example, data of a plurality of foods) stored in the value data memory by a selector (for example, select switch) Furthermore, according to the selected value data (for example, pork, cabbage, noodles, and sauce), a special award is provided (game media such as a predetermined number of medals are paid out). Thus, a player can acquire a special award by selecting the accumulatively stored value data. Therefore, a gaming machine having a system for giving a player an incentive to continue playing the game by being provided with a new game form in which value data is stored during continuing of gaming and the player selects value data by a selector from the plurality of stored value data, can be provided.

The present invention is not limited to the above-described embodiments, and as a matter of course, the present invention can be altered and varied in various ways without departing from the spirit of the present invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A gaming machine comprising:
a display device which displays a plurality of symbols;
a storage device which stores value data; and
a control device which controls game progress and the display device, wherein
the control device executes a variable displaying game which performs variable display and stopping display of the plurality of symbols and provides a predetermined award when the plurality of symbols are stopped and displayed in a predetermined combination in the variable displaying game, and
judges whether the result of each variable displaying game is as predetermined, and when the judging result is as predetermined, displays a specific value on the display device separately from provision of the predetermined award, stores value data relating to the specific value in the storage device, and provides a special award according to value data accumulatively stored in the storage device.

2. The gaming machine according to claim 1, wherein the control device performs control to display an image corresponding to value data stored in the storage device.

3. The gaming machine according to claim 1, wherein the control device selects value data from a plurality of value data stored in the storage device, and provides a special award according to the selected value data.
